(19) United States
(12) Patent Application Publication
(10) Pub. No.: US 2026/0235392 A1
(43) Pub. Date: Aug. 13, 2026

(54) MANIPULATING FREE SPECTRAL RANGE SHIFT IN INTEGRATED PHOTONIC MACH-ZEHNDER INTERFEROMETERS

(71) Applicant: Raytheon Company, Arlington, VA (US)

(72) Inventors: Liangshun Han, La Jolla, CA (US); Ping Piu Kuo, San Diego, CA (US); Ivan Shubin, San Diego, CA (US)

(21) Appl. No.: 19/049,615

(22) Filed: Feb. 10, 2025

(51) Int. Cl. G01B 9/02015

(52) U.S. Cl. CPC G01B 9/02015

(57) ABSTRACT

A Mach-Zehnder interferometer includes a first delay arm, a second delay arm, a first phase shifter, a second phase shifter, a third phase shifter, an input optical coupler connected to the first delay arm and the second delay arm, and an output optical coupler connected to the first delay arm and the second delay arm. The first phase shifter is provided on the first delay arm. The second phase shifter is provided on the second delay arm. The third phase shifter is provided on the second delay arm.

### TECHNICAL FIELD

This disclosure relates generally to integrated photonic circuits. More specifically, this disclosure relates to manipulating the free spectral range shift in integrated photonic Mach-Zehnder interferometers.

### BACKGROUND

Integrated photonic circuits present significant promise in terms of low power consumption, high bandwidth, and high integration density. They can be particularly advantageous in optical digital and analog systems for applications such as telecommunications, data centers, RF systems, and advanced computing systems. Mach-Zehnder interferometers (“MZIs”), such as MZIs that include active optical phase shifters (“PS”), are a fundamental building block in many integrated photonic circuit designs. However, unwanted free spectral range (“FSR”) shift of MZIs during phase tuning and limitations on tuning the FSR of MZIs can present various performance bottlenecks.

### SUMMARY

This disclosure relates to manipulating the free spectral range shift in integrated photonic Mach-Zehnder interferometers.

In some examples, a Mach-Zehnder interferometer includes a first delay arm, a second delay arm, a first phase shifter, a second phase shifter, a third phase shifter, an input optical coupler connected to the first delay arm and the second delay arm, and an output optical coupler connected to the first delay arm and the second delay arm. The first phase shifter is provided on the first delay arm. The second phase shifter is provided on the second delay arm. The third phase shifter is provided on the second delay arm.

Any single one or any combination of the following features may be used with the examples above. The first phase shifter can be a thermo-optic phase shifter including an optical waveguide of a first type of optical waveguide, the second phase shifter can be a thermo-optic phase shifter including an optical waveguide of a second type of optical waveguide, the third phase shifter can be a thermo-optic phase shifter including an optical waveguide of the first type of optical waveguide. A group-index sensitivity to temperature of the first type of optical waveguide can be larger than a group-index sensitivity to temperature of the second type of optical waveguide. An effective-index sensitivity to temperature of the first type of optical waveguide can be smaller than an effective-index sensitivity to temperature of the second type of optical waveguide. The first type of optical waveguide can include a substrate, a first core, at least one second core interacting with the first core, and one or more dielectric layers covering the first core and the at least one second core. The second type of optical waveguide can include a second substrate, a third core, and one or more second dielectric layers covering the third core. The first and the second substrates can be formed of the same material (for example, glass or silicon). The first and third cores can be formed of the same material. The first phase shifter can include at least one heater proximate to the optical waveguide of the first type of optical waveguide to tune a first phase shift and a first group delay of the first delay arm via a thermo-optic effect. The second phase shifter can include at least one heater proximate to the optical waveguide of the second type of optical waveguide to tune a second phase shift and a second group delay of the second delay arm via the thermo-optic effect. The third phase shifter can include at least one heater proximate to the optical waveguide of the first type of optical waveguide. The at least one second core can have a lower refractive index than the first core. The at least one second core can have a lower thermo-optic coefficient than the first core. The one or more dielectric layers can have a lower refractive index than the first and second cores and a lower thermo-optic coefficient than the first core. The one or more dielectric layers can include at least one of: a silicon dioxide layer, a silicon oxynitride (SiON) layer, a silicon nitride layer, a fluorosilicate glass layer, a borosilicate glass layer, a phosphosilicate glass layer, borophosphosilicate glass layer, a carbon doped oxide layer, an organic polymer layer, and other low refractive index materials. The first phase shifter, the second phase shifter, and the third phase shifter can be configured to concurrently provide a desired differential phase shift between the first delay arm and the second delay arm and a desired free spectral range. The first phase shifter can be an electro-optic phase shifter including an optical waveguide of a first type of optical waveguide. The second phase shifter can be an electro-optic phase shifter including an optical waveguide of a second type of optical waveguide. The third phase shifter can be an electro-optic phase shifter including an optical waveguide of the first type of optical waveguide. A group-index sensitivity to electrical field intensity across the first type of optical waveguide can be larger than a group-index sensitivity to electrical field intensity of the second type of optical waveguide. An effective-index sensitivity to electrical field intensity across the first type of optical waveguide can be smaller than an effective-index sensitivity to electrical field intensity of the second type of optical waveguide. The first type of optical waveguide can include a substrate, a first core, at least one second core interacting with the first core, and one or more dielectric layers covering the first core and the at least one second core. The second type of optical waveguide can include a second substrate, a third core, and one or more second dielectric layers covering third first core. The first and second substrates can be formed from the same material. The first phase shifter can include at least two electrodes proximate to the optical waveguide of the first type of optical waveguide in the first delay arm and configured to tune phase shift and group delay of the first delay arm via an electro-optic effect. The second phase shifter can include at least two electrodes proximate to the optical waveguide of the second type of optical waveguide in the second delay arm and configured to tune phase shift and group delay of the second delay arm via the electro-optic effect. The third phase shifter can include at least two electrodes proximate to the optical waveguide of the first type of optical waveguide in the second delay arm and can be configured to tune phase shift and group delay of the second delay arm via the electro-optic effect. The at least one second core can have a lower refractive index than the first core. The at least one second core can have a lower electro-optic coefficient than the first core. The one or more dielectric layers can have a lower refractive index than the first and second cores and a lower electro-optic coefficient than the first core. The one or more dielectric layers can include at least one of: a silicon dioxide layer, a silicon oxynitride (SiON) layer, a silicon nitride layer, a fluorosilicate glass layer, a borosilicate glass layer, a phosphosilicate glass layer, borophosphosilicate glass layer, a carbon doped oxide layer, an organic polymer layer, and other low refractive index materials. The first phase shifter, the second phase shifter, and the third phase shifter can be configured to concurrently provide a desired differential phase shift between the first delay arm and the second delay arm and a desired free spectral range. The input optical coupler can be one of: a multimode interference coupler, a directional coupler, or an adiabatic coupler. The output optical coupler can be one of: a multimode interference coupler, a directional coupler, or an adiabatic coupler. The Mach-Zehnder interferometer can include a fourth phase shifter, and the fourth phase shifter can be provided on the first delay arm and can be configured to provide phase tuning and group delay tuning of the first delay arm. The Mach-Zehnder interferometer can include one or more optical mode converters configured to convert an optical mode of the first type of optical waveguide to an optical mode of the second type of optical waveguide.

In other examples, a cascaded Mach-Zehnder interferometer includes a plurality of delay arm pairs, where each delay arm pair of the plurality of delay arm pairs includes at least one of an input optical coupler and an output optical coupler. The input optical coupler of a first delay arm pair is configured to receive an optical input signal. The output optical coupler of a last delay arm pair is configured to output an optical signals. The first delay arm pair and the last delay arm pair are connected directly via an intermediate optical coupler or indirectly by one or more delay arm pairs of the plurality of delay arm pairs.

Any single one or any combination of the following features may be used with the examples above. Each delay arm pair can include a first phase shifter, a second phase shifter, and a third phase shifter. The first phase shifter can be provided on a first delay arm of the delay arm pair. The second phase shifter can be provided on a second delay arm of the delay arm pair. The third phase shifter can be provided on the second delay arm of the delay arm pair. In each delay arm pair, the first phase shifter can include an optical waveguide of a first type of optical waveguide, the second phase shifter can include an optical waveguide of a second type of optical waveguide, and the third phase shifter can include an optical waveguide of the first type of optical waveguide. A group-index sensitivity to temperature or electrical field intensity of the first type of optical waveguide can be larger than a group-index sensitivity to temperature or electrical field intensity of the second type of optical waveguide. An effective-index sensitivity to temperature of or an electrical field intensity across the first type of optical waveguide can be smaller than an effective-index sensitivity to temperature or an electrical field intensity across of the second type of optical waveguide. The first type of optical waveguide can include a substrate, a first core, at least one second core interacting with the first core, and one or more dielectric layers covering the first core and the second core. The second type of optical waveguide can include a substrate, a first core, and one or more dielectric layers covering the first core. In each delay arm pair, the at least one second core can have a lower refractive index than the first core. In each delay arm pair, the at least one second core can have a lower thermo-optic coefficient or electro-optic coefficient than the first core. In each delay arm pair, the one or more dielectric layers can have a lower refractive index than the first and second cores and a lower thermo-optic coefficient or electro-optic coefficient than the first core. The cascaded Mach-Zehnder can include heaters proximate to the optical waveguides of the first and second types and configured to induce temperature changes in the optical waveguides. The cascaded Mach-Zehnder interferometer can include electrodes proximate to the optical waveguides of the first type and the optical waveguides of the second type and configured to induce electrical field changes across the optical waveguides. The cascaded Mach-Zehnder interferometer can include one or more fourth phase shifters, and the one or more fourth phase shifters can include one or more optical phase shifters of the second type of optical phase shifters. The one or more fourth phase shifters can be provided on the first delay arms of one or more delay arm pairs to provide phase tuning and group delay tuning.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-1H illustrate examples of technical challenges addressed by a compensated Mach-Zehnder interferometer according to this disclosure;

FIGS. 2A-2O illustrate an example of a compensated Mach-Zehnder interferometer and the spectral response data of same according to this disclosure;

FIGS. 3A-3C illustrate another example of a compensated Mach-Zehnder interferometer according to this disclosure;

FIGS. 4A-4C illustrate yet another example of a compensated Mach-Zehnder interferometer according to this disclosure;

FIGS. 5A and 5B illustrate an example of a waveguide transition area suitable for use in a compensated Mach-Zehnder interferometer according to this disclosure; and

FIG. 6 illustrates an example of a cascaded Mach-Zehnder interferometer including a plurality of connected delay arm pairs according to this disclosure.

### DETAILED DESCRIPTION

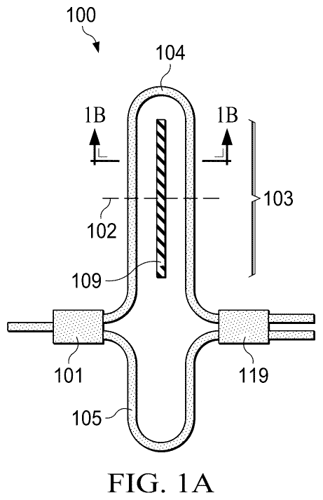

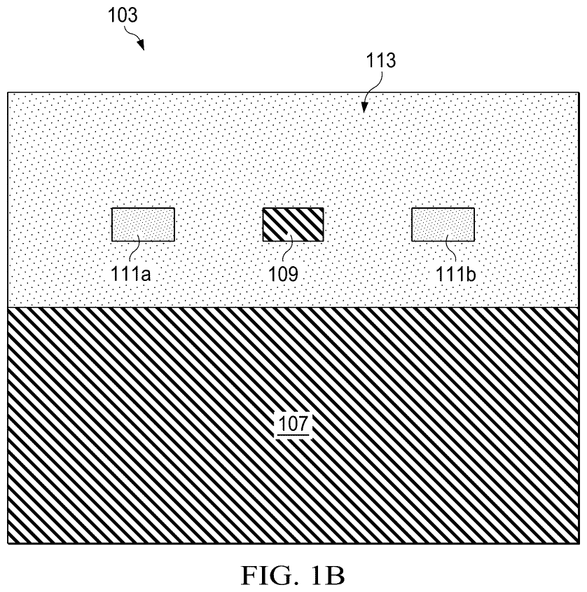

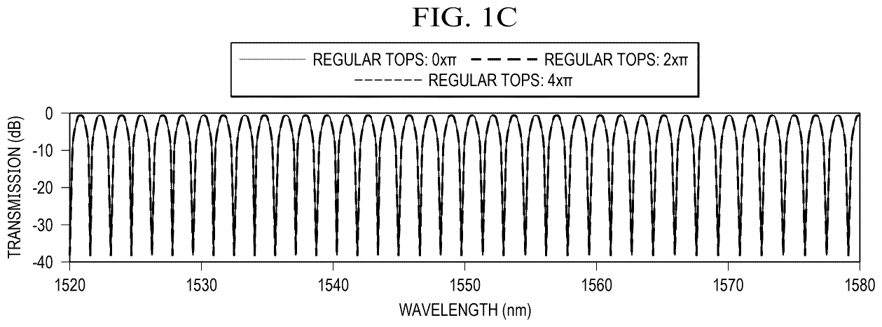

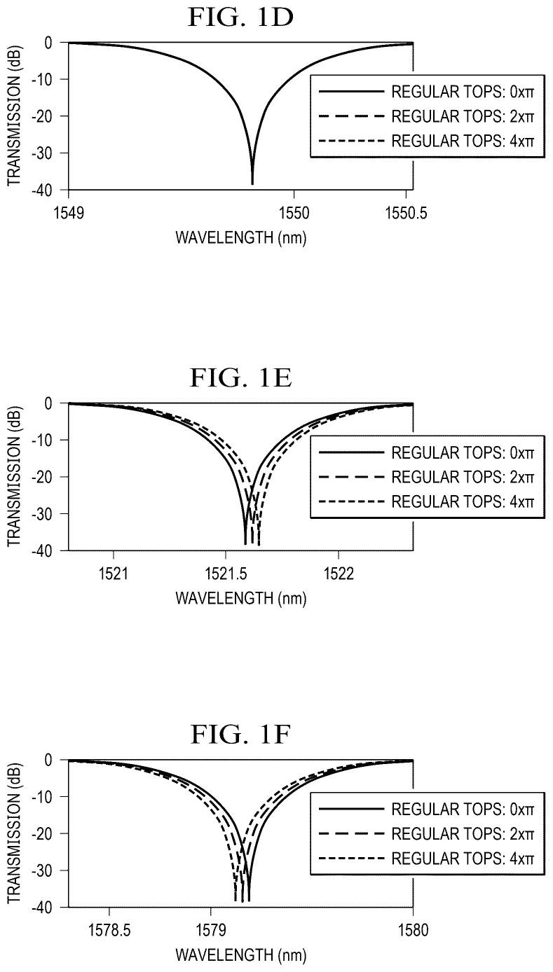

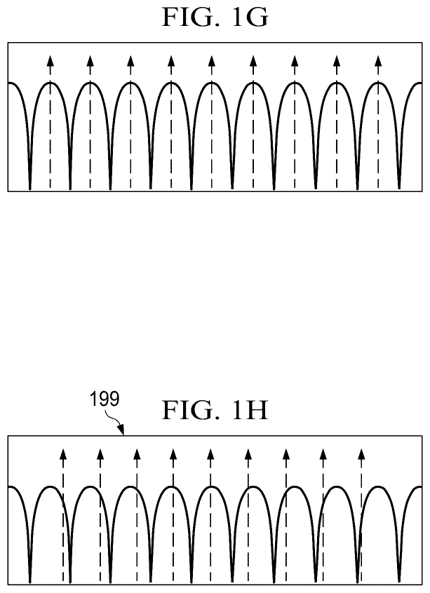

FIGS. 1A through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, integrated photonic circuits present significant promise in terms of low power consumption, high bandwidth, and high integration density. They can be particularly advantageous in optical digital and analog systems for applications such as telecommunications, data centers, RF photonics systems, and advanced computing systems. Mach-Zehnder interferometers (“MZIs”), such as MZIs that include active optical phase shifters (“PS”), are a fundamental building block in many integrated photonic circuit designs. A typical MZI includes two paths, where at least one path has an index of refraction that can be modulated in response to a control signal. The signals along the separate paths can be rejoined, and an output of the MZI can be a function of whether the index of refraction on one of the arms was modulated. In this way, MZIs can function as logical switches, interleavers, filters, modulators, or other optical devices.

The predicted improvements in processing power from electro-optic switching and signal modulation derive in part from the fact that optical devices can often perform switching tasks faster and with less energy than electrical devices. However, MZIs can be susceptible to free spectral range (“FSR”) drift during phase tuning enabled by thermo-optic or electro-optic effects, where the free spectral range of the MZIs varies under different phase shift values. Such variation can limit the optical bandwidth of the optical systems where the MZIs are deployed. Additionally, wide FSR tunability is desired as wide FSR tuning range, for example, provides flexibilities for removing the mismatch between FSR of the MZI-based interleaver and frequency pitch of optical frequency tones, improves device yield by correcting fabrication-caused FSR errors, and offers FSR reconfigurability to optical systems. Traditional waveguides used in optical PS in MZIs typically have small group-index sensitivity to temperature or electrical field intensity, which can limit the FSR tuning range of the MZIs using a thermo-optic effect or an electro-optic effect. This disclosure provides various MZI architectures that include one or more optical phase shifters with higher group-index sensitivity to temperature or electrical field intensity and weak phase shift in response to temperature or electrical field intensity change, which can mitigate FSR shift during phase tuning enabled by thermo-optic or electro-optic effects and provide enhanced FSR tunability.

FIGS. 1A-1H illustrate examples of technical challenges addressed by a Mach-Zehnder interferometer according to this disclosure. FIG. 1A illustrates an example of known “regular” photonic integrated 1×2 (one input and two outputs) Mach-Zehnder interferometer (“MZI”) 100. MZI 100 includes an input optical coupler 101, which splits the input optical signal into two beams. One light beam is coupled to a first delay arm 103, and the second light beam is coupled a second delay arm 105. After propagating through the delay arms, two light beams are combined through an output coupler 119. The number of input and output ports can vary if needed or desired. The first delay arm includes a “standard” (called as “regular” or “conventional”) thermo-optic phase shifter to provide optical phase tuning.

FIG. 1B illustrates a cross-sectional view of first delay arm 103 along dash line 102. First delay arm 103 includes a regular thermo-optic phase shifter (“TOPS”) 104, which includes a substrate 107 (such as a layer of glass or silicon), a heater 109, and one or more silicon waveguides 111a-111b. Heater 109 and silicon waveguides 111a-111b are embedded in a silicon dioxide cladding layer 113 and supported by substrate 107. By applying an electrical current to heater 109, the effective index of the waveguide of TOPS 104 can be changed, and a resulting phase shift is introduced due to an induced thermo-optic effect in the silicon and silicon dioxide layers. However, this phase tuning process typically introduces a group index change of the waveguide.

The relationship between effective-index sensitivity to temperature and group-index sensitivity to temperature of a waveguide can be expressed as:

$$\frac{\partial {n}_{g} ( λ , T )}{\partial T} = \frac{\partial {n}_{eff} ( λ , T )}{\partial T} - λ \frac{\partial }{\partial T} \{ \frac{\partial {n}_{eff} ( λ , T )}{\partial λ} \} \qquad ( 1 )$$

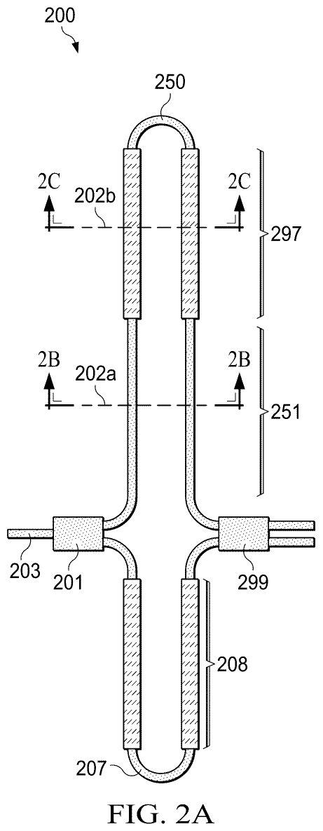

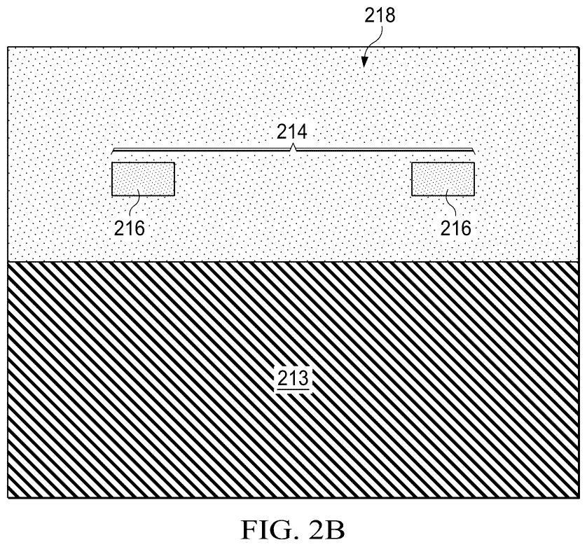

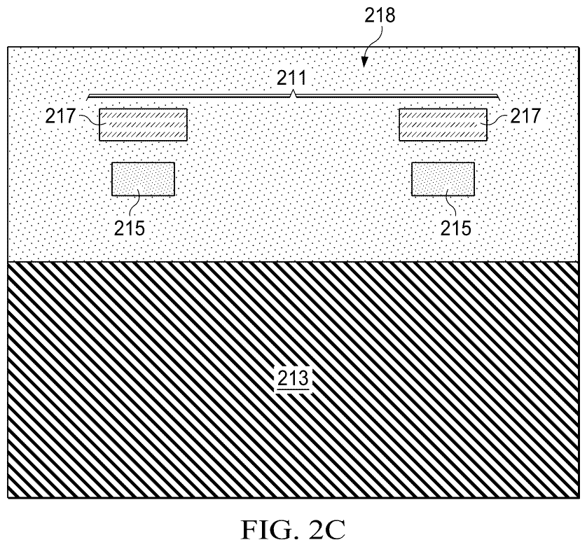

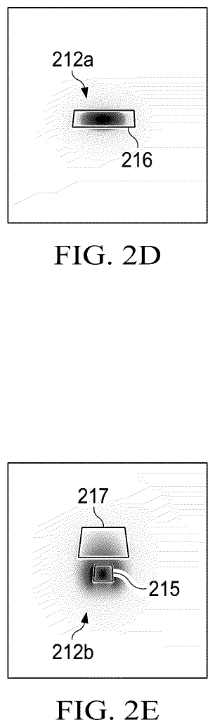

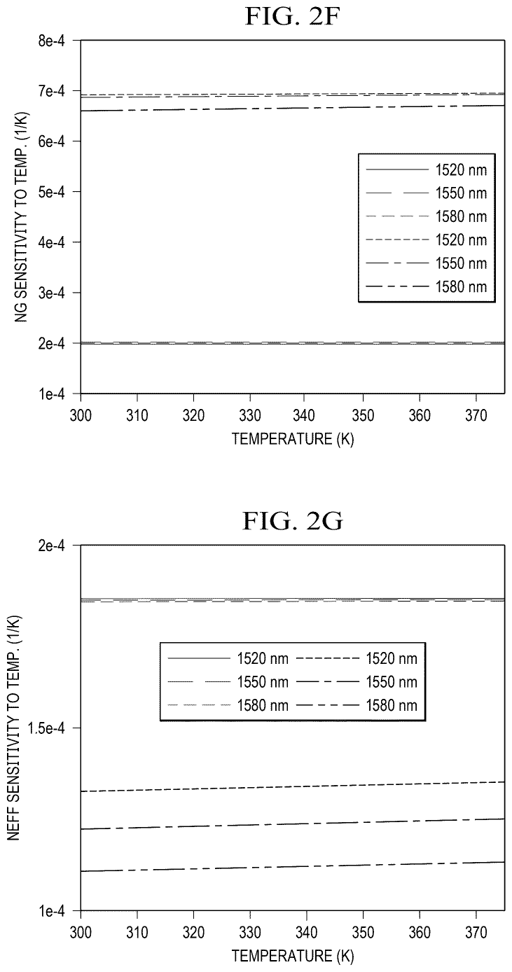

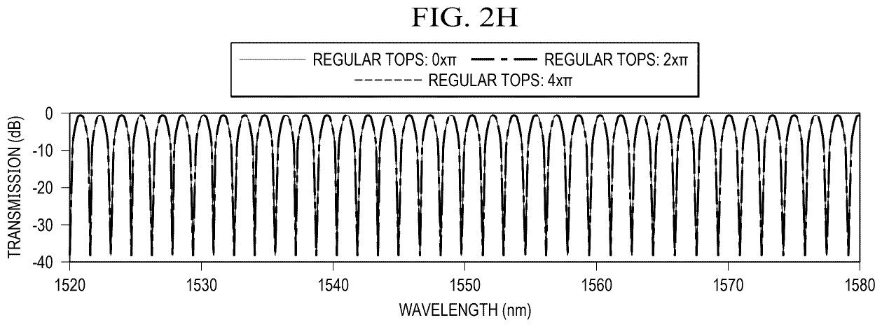

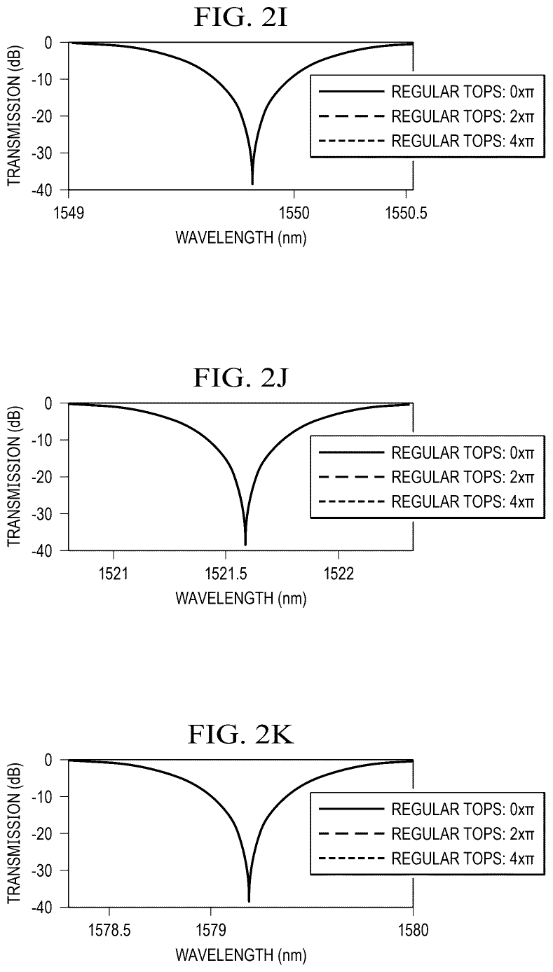

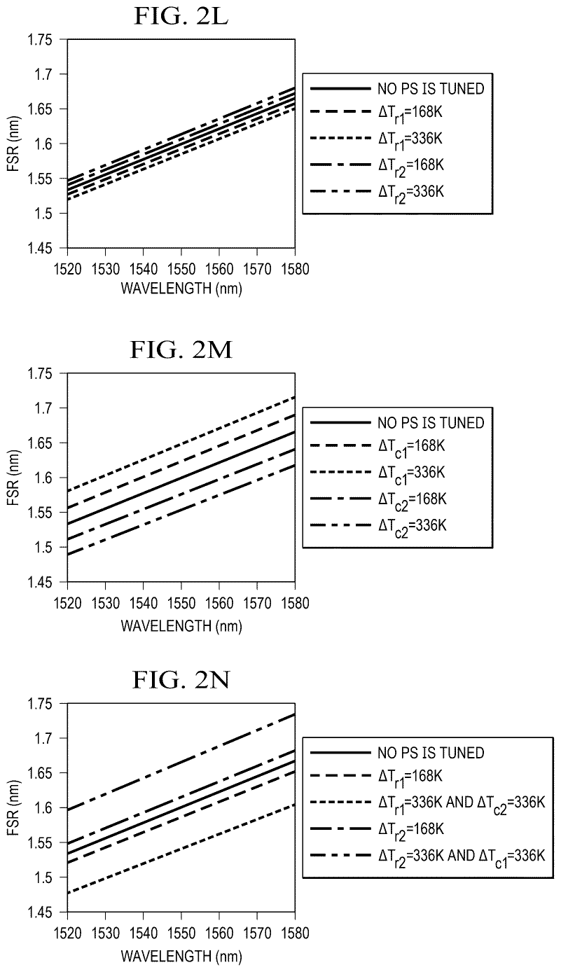

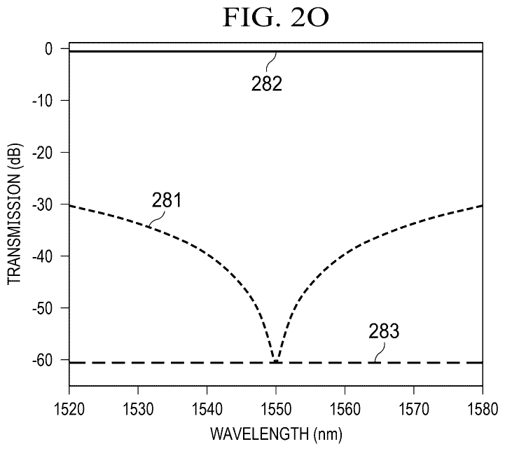

Here, n_{g}, n_{eff}, T, and λ are the group index, effective index of the waveguide, the temperature of the waveguide, and optical wavelength, respectively. In conventional waveguides, the second term on right hand side of Equation (1) is much smaller relative to the first term. This implies that group index has a similar sensitivity to T as that of the effective index. Example results of group-index sensitivity to temperature and effective-index sensitivity to temperature of a regular silicon waveguide are shown in FIG. 2F-2G of this disclosure. In a Mach-Zehnder interferometer, the group index of the waveguide of the arms determines the FSR of the MZI. The relationship between FSR, waveguide length, and group index can be expressed as:

$$FSR ( nm ) = {λ}^{2} / ( \vert {n}_{g 1} {L}_{1} - {n}_{g 2} {L}_{2} \vert ) \qquad ( 2 )$$

Here, Lᵢ and n_{gi} are the waveguide length and group index, respectively, of arm i (i=1,2), λ is the central wavelength, and FSR (nm) is the free spectrum range of MZI in nanometers. As a result of a group index change caused by increased temperature for obtaining a phase shift from TOPS, the FSR of the MZI shifts during the phase tuning process. More illustrative details can be found in FIGS. 1C-F.

FIG. 1C illustrates example transmission spectra for MZI 100 at phase shifts of 0 radians, 2π radians, and 4π radians for light signals across a range of wavelengths between 1520 nm and 1580 nm. The phase shifts shown in FIG. 1C can be attained by tuning TOPS 104.

FIGS. 1D-1F provide more detailed views of the transmission spectra at phase shifts of 0 radians, 2π radians, and 4π radians across wavelengths near a center band of 1550 nm (FIG. 1D), a first sideband near 1520 nm (FIG. 1E), and a second sideband near 1580 nm (FIG. 1F). The phase shifts are obtained using the TOPS. As shown in FIG. 1D, at the center band wavelength, troughs of the three phase shift cases are aligned at the same wavelength. However, the troughs of the three phase shift cases are misaligned at both shorter and longer wavelength sidebands as shown in FIGS. 1E and 1F. Such misalignments are the sign of FSR shifts when phase shift is induced by TOPS 104. FSR shift is generally undesirable in photonic systems. For example, FSR shift can limit the optical bandwidth of MZI-based photonic systems. In systems with multiple concatenated MZIs, FSR shift can create crosstalk issues due to differences in FSR shift across interferometers.

By exposing the waveguide portion of an MZI to an electric field of variable intensity, an electro-optic effect is induced, which can be used to tune the phase of optical signals passing through the MZI. The phase shift associated with such electro-optical effects can be given by Equation (3), below, which modifies Equation (1) to account for electro-optical effects.

$$\frac{\partial {n}_{g} ( λ , E )}{\partial E} = \frac{\partial {n}_{eff} ( λ , E )}{\partial E} - λ \frac{\partial }{\partial E} \{ \frac{\partial {n}_{eff} ( λ , E )}{\partial λ} \} \qquad ( 3 )$$

Here, E is the electrical field intensity across the waveguide. In conventional waveguides, the second term on right hand side of Equation (3) is much smaller relative to the first term. In such cases, this implies that group index has similar sensitivity to E as that of effective index. As a result of a group index change caused by an increased electrical field intensity across the waveguide for obtaining phase shift from electric-optic phase shifter (“EOPS”), the FSR of the MZI can drift during the phase tuning process.

Another limitation of certain known MZIs is that phase shifters based on thermo-optic effect or electro-optic effects can exhibit limited group-index sensitivity, which, while sufficient to create confounding FSR shifts, is still generally low. In practical terms, this translates to a limited capacity for tuning the FSR of an MZI to compensate for manufacturing issues (such as geometric variations in waveguides of MZI delay arms) and to tune the FSR for specific applications.

FIGS. 1G and 1H illustrate aspects of the technical challenges posed by limited FSR tuning. FIG. 1G illustrates an ideal match between a regular set of optical frequency tones (shown as vertical arrows) and the transmission spectrum of an MZI. In this idealized example, the spacing of the optical frequency tones is regular and aligns with the passbands of the MZI. Put differently, the FSR of the MZI providing the transmission spectrum shown in FIG. 1G matches with the spacing of the frequency tones. For certain devices, such as interleavers, this alignment is desirable and conducive to increased bandwidth of the system.

FIG. 1H illustrates a less-than-ideal match between a regular set of optical frequency tones (again shown as vertical arrows) and the transmission spectrum of an MZI. As shown in FIG. 1H, while the passbands of the transmission spectrum of the MZI generally align with the spacing of the optical frequency tones at wavelengths around a central wavelength 199, the FSR of the MZI does not match the spacing of the optical frequency tones. This can limit the range of wavelengths over which the MZI can, for example, operate as an interleaver to a range of wavelengths centered around central wavelength 199. Accordingly, being able to not only avoid FSR drift (as described with reference to FIGS. 1A-1F) but also being able to tune the FSR of an MZI in a wide range presents opportunities for improvement in the art.

FIGS. 2A-2O illustrate an example of an MZI 200 according to this disclosure. For consistency and convenience of cross-reference, elements already described or shown in more than one of FIGS. 2A-2O are numbered similarly.

MZI 200 can be configured to address the FSR shift issues described with reference to FIGS. 1A-1F and resolve the limits on FSR tuning range issue described with reference to FIGS. 1G-1H. As shown in FIG. 2A, MZI 200 includes a 1×2 MZI and includes an input optical coupler 201, which receives optical signals at one or more wavelengths from a waveguide 203. As shown in FIG. 2A, input optical coupler 201 splits the received optical signals in two and routes a first signal of the split signals to a first delay arm 207 connected at a first end to input optical coupler 201 and connected at a second end to an output optical coupler 299. Input optical coupler 201 also routes a second signal of the split optical signals to a second delay arm 250, which is connected at a first end to input optical coupler 201 and connected at a second end to output optical coupler 299. In some embodiments, each of input optical coupler 201 and output optical coupler 299 can be a multimode interference coupler, a directional coupler, or an adiabatic coupler. Also, in some embodiments, first delay arm 207 can be of a different length than second delay arm 250, resulting in the light of one optical signal taking slightly longer to traverse the longer delay arm. Further, in some embodiments, first delay arm 207 can be of an equal length as second delay arm 250, resulting in both optical signals taking equal time to traverse the delay arms (such as an MZI with an infinite FSR).

MZI 200 can mitigate FSR shift effects by providing two types of optical phase shifters (“PS”) within the delay arms of MZI 200. A first type of optical PS (referred to herein as a “regular” optical PS) is constructed from materials selected to provide strong phase shift in response to temperature or electrical field changes and minimal group-index shift in response to temperature or electrical field. As discussed elsewhere, while effective at inducing phase shifts, regular optical PS induces FSR shifts to MZI 200. A second type of optical PS (referred to herein as a “compensating” or “compensated” optical PS) is constructed from materials selected to provide weak phase shift in response to temperature or electrical field but strong group-index sensitivity to temperature or electrical field. More specifically, the second type of optical PS has a stronger group-index shift to temperature or electrical field in contrast to the first type of optical PS. For clarity, heaters for modulating waveguide temperatures or electrodes for induing electrical fields across waveguides of the two types of optical PS are not shown in FIGS. 2A-2B.

In the example of FIG. 2A, first delay arm 207 includes a first compensating optical PS 208. FIG. 2C shows the cross-sectional view of optical waveguide of compensating optical PS 208, which is taken at dash line 202b in FIG. 2A. As shown in FIG. 2C, the first compensating optical PS 208 includes a substrate 213, which may represent a section of glass or other substrate material suitable for use in integrated photonic circuits. First compensating optical PS 208 also includes a compensating waveguide 211, which appears twice in the cross-sectional view of FIG. 2C due to the U-shape of first delay arm 205. Compensating waveguide 211 can include a first core 215 and a second core 217. As shown in FIG. 2C, the second core 217 can be disposed above the first core 215 relative to substrate 213. In some embodiments, the second core 217 can include multiple material layers. In some embodiments, the second core 217 may not cover the first core 215. In some embodiments, to enhance the group index sensitivity of first compensating optical PS 208, the second core 217 can be thicker and wider than the first core 215. For example, in particular embodiments, the first core 215 is a silicon core layer, and the second core layer is silicon nitride core layer. The silicon core layer can have an effective width of 320 nm and a thickness of 220 nm, and the second core 217 (for example, a silicon nitride layer) can have an effective width of 800 nm and a thickness of 400 nm. The separation gap between the silicon nitride and silicon layers can be 100 nm. In this waveguide example, the thermo-optic effect may be utilized for first compensating optical PS 208. MZI 200 can further include a second compensating optical PS 297 having the same waveguide structure and optical properties as the first compensating optical PS 208.

As shown in FIG. 2A, MZI 200 can further include at least one regular optical PS 251. The regular optical PS 251 is disposed on the second delay arm 250. FIG. 2B shows the cross-sectional view of optical waveguide of optical PS 251, which is taken at dash line 202a in FIG. 2A. As shown in FIG. 2B, the regular optical PS 251 includes a substrate 213, which may represent a section of glass or other substrate material suitable for use in integrated photonic circuits. The regular optical PS 251 also includes a regular waveguide 214, which appears twice in the cross-sectional view of FIG. 2B due to the U-shape of second delay arm 250. Regular waveguide 214 can include a core 216. The differential phase between first delay arm 207 and second delay arm 250 induced by the three optical phase shifters can be given by Equation (4), below:

$$P S = ( \frac{\partial {n}_{e , r 1} ( λ , X )}{\partial X} Δ {X}_{r 1} ) \frac{{L}_{r 1}}{λ} 2 π + ( \frac{\partial {n}_{e , c 2} ( λ X )}{\partial X} Δ {X}_{c 2} ) \frac{{L}_{c 2}}{λ} 2 π - ( \frac{\partial {n}_{e , c 1} ( λ , X )}{\partial X} Δ {X}_{c 1} ) \frac{{L}_{c 1}}{λ} 2 π \qquad ( 4 )$$

### Here,

$$\frac{\partial {n}_{e , i} ( λ X )}{\partial X} ,$$

Lᵢ and ΔXᵢ are the effective-index sensitivity to X, waveguide length, and X increase for an optical phase shifter i, where (i=r1, c1, c2, where r1, c1, and c2 represent the first regular optical PS 251, the first compensating optical PS 208, and the second compensating optical PS 297). X in Equation (3) refers to the temperature of the waveguide as controlled by a heater or the electrical field applied across the waveguide.

The FSR of MZI 200 can be expressed by Equation (5) below:

$$FSR ( nm ) = \frac{{λ}^{2}}{\vert {n}_{g , r 1} {L}_{r 1} + {n}_{g , c 2} {L}_{c 2} - {n}_{g , c 1} {L}_{c 1} + {Δ}_{n g l} \vert} \qquad ( 5 )$$

Here, n_{g,i} and Lᵢ are the group-index sensitivity to X and waveguide length of optical PS i (i=r1, c1, c2, where r1, c1, and c2 represent the first regular optical PS 251, the first compensating optical PS 208, and the second compensating optical PS 297), and Δn_{gl} is the contribution from other waveguides in the two delay arms.

The relationship between n_{g,i} and X change can be expressed by Equation (6), below:

$${n}_{g , i} = {n}_{g 0 , i} + \frac{\partial {n}_{g , i} ( λ , X )}{\partial X} Δ {X}_{i} \qquad ( 6 )$$

Here, n_{g0,i} is the group index when no X change is introduced to the waveguide. Equations (4)-(6) establish that (ΔXᵣ₁, ΔX_{c1} and ΔX_{c2}) are three parameters which can be tuned together to attain desired differential phase shift and desired FSR of MZI 200.

In some applications, FSR shift may need to be minimized during phase tuning. In this example structure of MZI 200, the second delay arm can be assumed to have larger group delay than the first delay arm (such as the light takes longer time to transverse the second delay arm). If to reduce the FSR as measured in meters to a desired value, ΔX_{c2} of optical PS 297 is first tuned with setting both ΔXᵣ₁ amd ΔX_{c1} as zero. Then, the desired phase can be attained by tuning ΔXᵣ₁ and ΔX_{c1} concurrently while maintaining FSR unchanged with fixed ΔX_{c2}. In this example, the relationship

$$\frac{\partial {n}_{g , r 1} ( λ , X )}{\partial X} Δ {X}_{r 1} {L}_{r 1} - \frac{\partial {n}_{g , c 1} ( λ , X )}{\partial X} Δ {X}_{c 1} {L}_{c 1} = 0$$

can be guaranteed during phase tuning (such as tuning to various differential phase values). In this example, to increase the FSR as measured in meters of MZI 200 to a desired value, compensating optical PS 297 does not necessarily need to be tuned (such as ΔX_{c2}=0), and instead, the desired phase can be attained by tuning ΔXᵣ₁ and ΔX_{c1} concurrently while maintaining the desired FSR value with ΔX_{c2}=0. According to this approach, the relationship

$$\frac{\partial {n}_{g , r 1} ( λ , X )}{\partial X} Δ {X}_{r 1} {L}_{r 1} - \frac{\partial {n}_{g , c 1} ( λ , X )}{\partial X} Δ {X}_{c 1} {L}_{c 1} = Constant$$

can be practically ensured during phase tuning (such as tuning to various differential phase values). As discussed here, the three optical PSs 297, 251, and 208 can be configured concurrently to provide a desired phase and a desired FSR. Equations (5) and (6) of this disclosure illustrate that, in order to attain an expanded FSR tuning range (such as FSR tuning efficiency), the instances of compensating waveguides 211 of the two compensating optical PS 297 and 208 should possess strong group-index sensitivity to X. Equation (4) illustrates that, in order to attain high phase tuning efficiency, the instances of waveguides 211 of the two compensating optical PS 208 and 297 should possess minimal effective-index sensitivity to X.

FIGS. 2D-2G illustrate the expected group-index and effective-index sensitivities to temperature of regular waveguide 214 in FIG. 2B and compensating waveguide 211 in FIG. 2C. In this example, waveguides 214 and 211's sensitivity to thermo-optic effects is considered. In this example, for the compensating waveguide, the first core 215 is silicon having an effective width of 320 nm and a thickness of 220 nm, and the second core 217 can be formed of a layer of silicon nitride with an effective width of 800 nm and a thickness of 400 nm. The separation gap between the silicon nitride and silicon layers may be 100 nm in this example. In some cases, a finite difference eigenmode solver can be used to simulate the waveguide properties of regular waveguide 214 and compensating waveguide 211.

In this example, for regular waveguide 214, the core 216 can be formed of silicon having an effective width of 1000 nm and a thickness of 220 nm. The dielectric layer in both waveguides may be silicon dioxide. FIG. 2D illustrates a calculated optical mode field distribution 212a in regular waveguide 214. FIG. 2E illustrates a calculated optical mode field distribution 212b in the compensating waveguide 211. In contrast to the mode field of regular waveguide 214, the field of compensating waveguide 211 not only distributes in the silicon core layer but also in the silicon nitride core layer. The differences in refractive index thermo-optic coefficients between silicon and silicon nitride (1.8×10⁴/° C. vs. 2.5×10⁻⁵/° C.) means optical field confinement in silicon increases when temperature increases. As silicon has a higher refractive index than silicon nitride (3.48 vs. 1.95), this leads to even higher group-index sensitivity to temperature (3.4×) in compensating waveguide 211 than in regular waveguide 214. Meanwhile, as the optical mode is less confined in silicon than the regular waveguide, the effective index shift, which corresponds to thermo-optic phase shift, is weaker in the compensating waveguide.

FIG. 2F illustrates a calculated group-index sensitivity to temperature of regular waveguide 214 and compensating waveguide 211. FIG. 2G illustrates effective-index sensitivity to temperature for both regular waveguide 214 and compensating waveguide 211. Consequently, an optical PS constructed using the compensating waveguide can provide strong group-index shift but weak phase shift, in contrast to a regular optical PS constructed using regular waveguide 214 in which strong phase shift and minimal group-index shift is sought. According to certain embodiments, the second core 217 can have a lower refractive index than first core 215, second core 217 can have a lower thermo-optic coefficient than first core 215, and dielectric layer 218 can have a lower refractive index than first and second cores 215 and 217 and a lower thermo-optic coefficient than the first core 215. When the optical properties of the waveguide are modulated by an electro-optic effect, it still holds that the second core 217 has a lower refractive index than the first core 215, the second core 217 has a lower electro-optic coefficient than first core 215, and dielectric layer 218 has a lower refractive index than the first and second cores 215-217.

FIG. 2H illustrates example transmission spectra for MZI 200 at phase shifts of 0 radians, 2π radians, and 4π radians for light signals across a range of wavelengths between 1520 nm and 1580 nm. The phase shifts can be attained by concurrently tuning the regular and compensating optical PSs. In this example, FSR drift due to thermo-optic effects is considered and accounted for through tuning of MZI 200.

In this example, it is assumed that second delay arm 250 has a larger group delay than the first delay arm 207, so light takes a longer time to traverse second delay arm 250 than first delay arm 207. In this example, for compensating waveguide 211, the first core 215 may be formed from silicon and may have an effective width of 320 nm and a thickness of 220 nm, and the second core 217 may be formed from silicon nitride and may have an effective width of 800 nm and a thickness of 400 nm. FIGS. 2I-2K provide more detailed views of the transmission spectra at phase shifts of 0 radians, 2π radians, and 4π radians across wavelengths near a center band of 1550 nm (FIG. 2I), a first sideband near 1520 nm (FIG. 2J), and a second sideband near 1580 nm (FIG. 2K). The phase shifts can be obtained using both the first regular optical PS 251 and the first compensating optical PS 208. As shown in FIGS. 2I-2K, by tuning MZI 200 as described herein, the troughs of the three phase shift cases can be kept well aligned, avoiding the misalignment described with reference to FIGS. 1D-1F.

FIGS. 2L-2N illustrate the enhanced FSR tunability of MZI 200 using the compensating waveguide in the compensating optical PSs (such as first compensating optical PS 208 or second compensating optical PS 297). When only regular optical PS 251 is tuned, FIG. 2L illustrates FSR as a function of wavelength at different waveguide temperatures. FIG. 2M illustrates the spread in possible FSR values as a function of waveguide temperature when only compensating optical PSs (such as first compensating optical PS 208 and second compensating optical PS 297) are tuned. FIGS. 2L-2N illustrate that, for a given waveguide temperature, a compensating optical PS can provide a larger FSR shift. The total FSR tuning range can be further expanded by using both regular and compensating optical PS concurrently as shown in FIG. 2N. As discussed above, the ability to tune the FSR of a Mach-Zehnder interferometer offers multiple performance benefits, such as the ability to tune the passband of the MZI to match the spacings of optical frequency tones, thereby addressing the problems discussed with reference to FIGS. 1G-1H.

FIG. 2O shows transmission spectra of MZI 200 configured for use in a wideband optical switch and that has been tuned as described herein to mitigate FSR shifts due to thermo-optical effects. In this example, first core 215 is formed of a layer of silicon with an effective width of 320 nm and a thickness of 220 nm, second core 217 is formed of a layer of silicon nitride with an effective width of 800 nm and a thickness of 400 nm, and core 216 of regular waveguide 214 is formed of a layer of silicon with an effective width of 1000 nm and a thickness of 220 nm. The intrinsic FSR of MZI 200 is infinite, which means the group delays of the two arms are of equal length when no additional group delay is induced by optical PS. The baseline state of the optical switch can be an ON state. The solid trace 282 in FIG. 2O shows the ON state optical transmission of the switch. To switch to an OFF state, optical PS provides a phase differential of π between the two delay arms. Trace 281 shows the transmission as a function of wavelength in the OFF state optical transmission of the switch when using regular optical PS 251 only. Trace 283 is the OFF state optical transmission of the switch when using both regular optical PS 251 and first compensating optical PS 208. As shown in FIG. 2O, when only the regular optical PS 251 is used, the FSR of the MZI ceases to be infinite, giving rise to the wing feature, which correlates to reduced bandwidth. Trace 283 shows constant lower optical power leakage than that of trace 281. This indicates the FSR shift is mitigated during thermo-optic phase tuning using both the first regular and the first compensating optical PSs together in MZI 200, resulting wider optical bandwidth of MZI based optical switches.

Although FIGS. 2A-2O illustrate one example of an MZI 200, embodiments according to the present disclosure are not so limited. For example, other input/output port combinations are possible and within the contemplated scope of this disclosure. As particular examples, output optical coupler 299 may provide a single output (such as in a 1×1 MZI) or provide more than two outputs (such as in a 1×n MZI, where n>2). Also, while regular optical PS 251 is shown here in a longer arm of MZI 200 and first compensating optical PS 208 is shown in a shorter arm of MZI 200, this arrangement may be reversed so that regular optical PS 251 is in the shorter arm and first compensating optical PS 208 is in the longer arm. Further, while the layer structure of first compensating optical PS 208 in FIG. 2C is described with reference to dimensions in which second core 217 is thicker and wider than first core 215 and second core 217 and first core 215 are spaced 100 nm apart, other embodiments with different spacings and different relative widths between second core 217 and first core 215 are possible. In addition, MZI 200 may include more than two optical pathways, in which case input optical coupler 201 may split a signal into more than two portions.

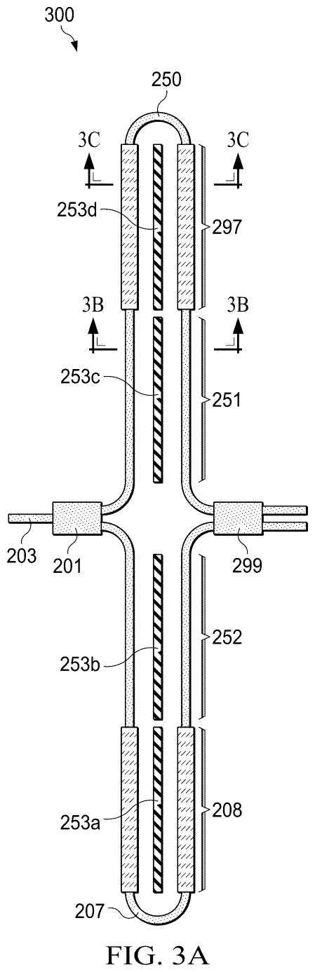

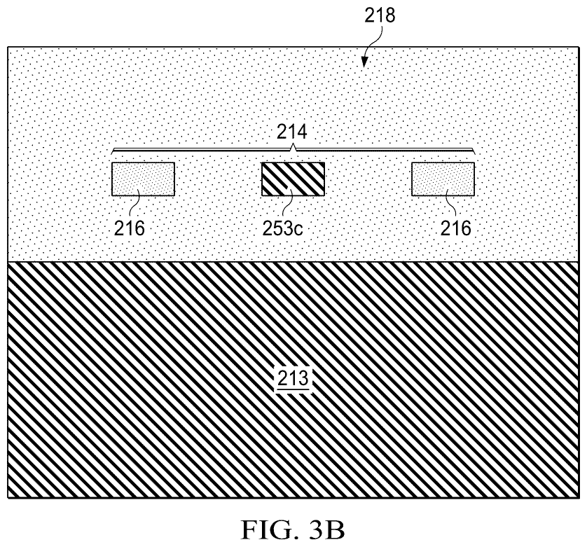

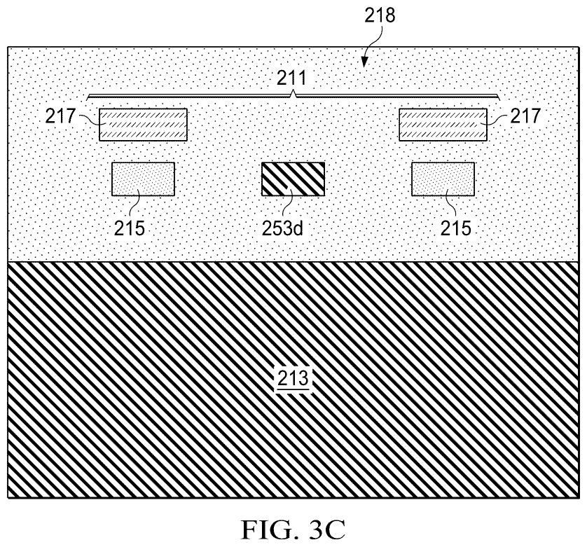

FIGS. 3A-3C illustrate another example of an MZI 300 using thermo-optic effects according to this disclosure. MZI 300 builds upon the architecture of MZI 200 by incorporating heaters 253a-253d adjacent to the waveguides to induce thermo-optic effects in each of delay arms 207 and 250 and by incorporating a second regular optical PS 252 in first delay arm 207. For consistency and convenience of cross-reference, elements of FIGS. 3A-3C discussed with reference to FIGS. 2A-2O are numbered similarly. As shown in FIGS. 3A and 3C, first compensating optical PS 208 now includes a heater 253a disposed adjacent to compensating waveguide 211. Each of heaters 253a-253d may include a layer of electrically resistive material or other suitable structure that changes temperature in response to the passage of electrical current, thereby eliciting a thermo-optic response in one or more of compensating waveguides 211 or regular waveguides 214. In some embodiments, the heater can be formed as part of first core 215 of compensating waveguide or core 216 of regular waveguide (referred to as a “in-waveguide” heater). In some embodiments, the heater may be placed at different locations in proximate to the waveguides due to fabrication constraints.

In some embodiments, regular optical PS 251 and second regular optical PS 252 may utilize the same construction and arrangement, including a waveguide straddling a heater element, where the waveguide core and heater element are disposed in a layer of dielectric layer and supported on a glass or other substrate such as shown in FIG. 3B. Also, in some embodiments, regular optical PS 251 may operate according to the same principles as the device described with reference to FIGS. 1A and 1D.

Although FIGS. 3A-3C illustrate another example of an MZI 300, embodiments according to the present disclosure are not so limited. For example, other input/output port combinations are possible and within the contemplated scope of this disclosure. As particular examples, output optical coupler 299 may provide a single output (such as in a 1×1 MZI) or provide more than two outputs (such as in a 1×n MZI, where n>2). Also, in some embodiments, MZI 300 can be one of a plurality of MZIs chained together to provide a logical switch. In addition, MZI 300 may include more than two optical pathways, in which case input optical coupler 201 can split a signal into more than two portions.

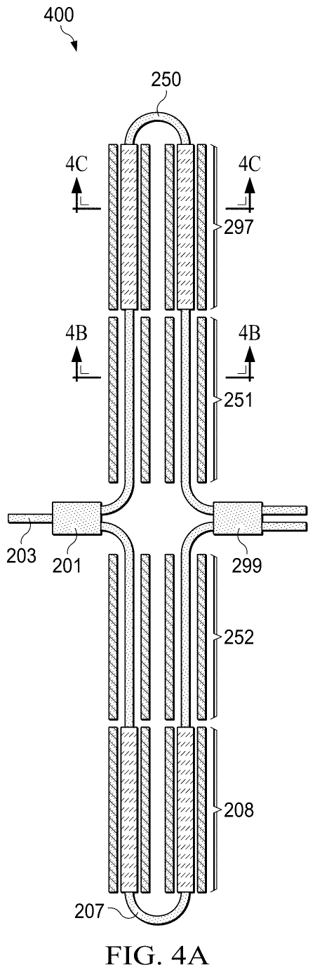

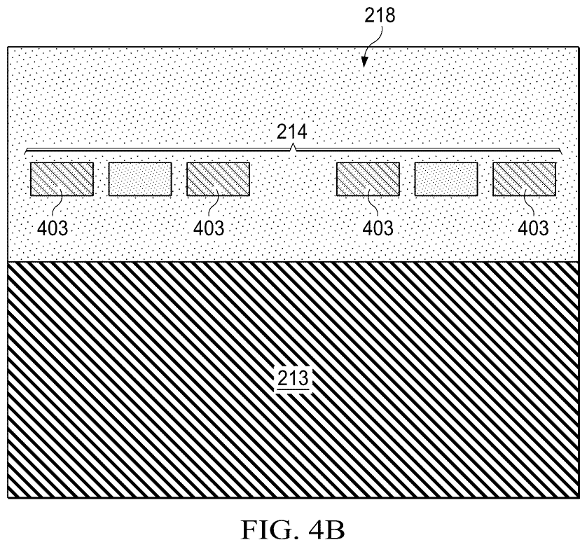

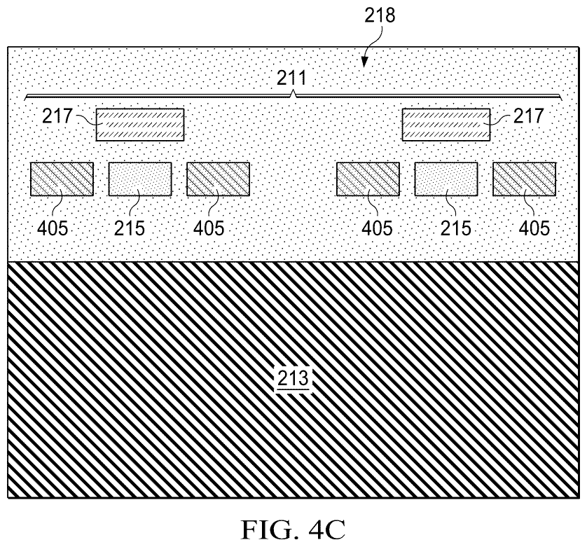

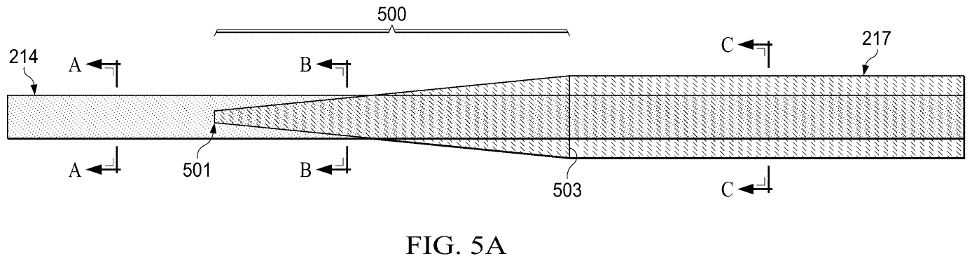

FIGS. 4A-4C illustrate yet another example of an MZI 400 according to this disclosure. MZI 400 embodies the same fundamental architecture of MZI 300. For consistency and convenience of cross-reference, elements of FIGS. 4A-4C described with reference to previous figures are numbered similarly.

As shown in FIG. 4A, MZI 400 includes first and second delay arms 207 and 250 connected to input optical coupler 201 and output optical coupler 299, where each delay arm includes a regular PS and a compensated PS. While MZI 400 can provide the same tuning opportunities as MZI 300, it differs from MZI 300 in that MZI 400 utilizes electro-optic effects instead of using thermo-optic effects to tune to alter optical properties of the waveguides in the delay arms. As shown in FIG. 4B, regular waveguide 214 is disposed between a first electrode pair 403 and compensating waveguide 211 is disposed between a second electrode pair 405. Both first electrode pair 403 and second electrode pair 405 can create an electric field, which induces electro-optical effects changing one or more optical properties of regular waveguide 214 and compensating waveguide 211. In some embodiments, the relative positions of first and second electrode pairs 403 and 405 can vary based on tradeoffs between tuning efficiency and other optical performances and based on the crystal orientation of core layers.

Although FIGS. 4A-4C illustrate one example of an MZI 400, embodiments according to the present disclosure are not so limited, and can, for example, include embodiments of an MZI which modulates the optical properties of the regular and compensating waveguides using the electro-optic effect, but with a compensating waveguide in only a single arm of the delay arm pair.

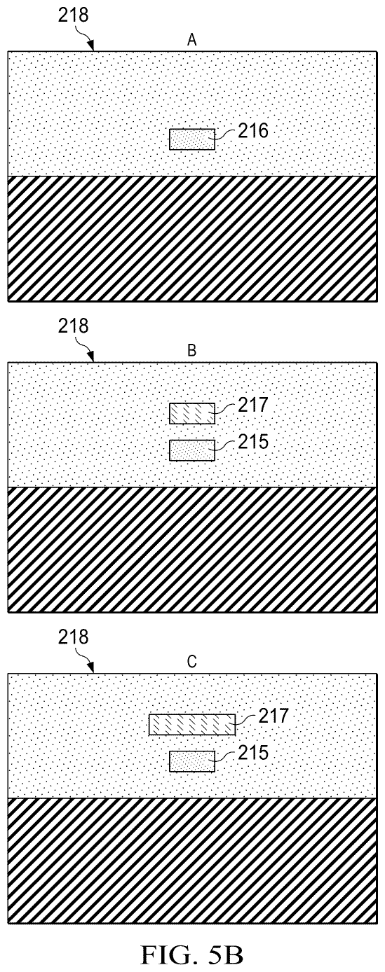

FIGS. 5A and 5B illustrate an example of a transition region 500 between a regular waveguide (such as regular waveguide 214) and a compensating waveguide (such as compensating waveguide 211) according to this disclosure. Due to the different mode profiles of a regular waveguide and a compensating waveguide, a waveguide transition may need to be provided between the waveguides along the light propagation direction to operate as an optical mode converter in order to convert a first optical mode of a first waveguide to a second optical mode of a second waveguide in a way that reduces or minimizes optical loss and substantially maintains the desired mode profiles. As such, transition region 500 operates as an optical mode converter to change optical modes between waveguides. As used in this disclosure, the expression “optical mode” encompasses, for a given section of waveguide, one of a possible plurality of orthogonal solutions for the propagation of light within the waveguide.

Referring to the illustrative example of FIG. 5A, an overhead, semi-transparent view of a transition region 500 between a first, regular waveguide (such as regular waveguide 214) and a second, compensating waveguide (such as compensating waveguide 211) is shown. As discussed elsewhere in this disclosure, regular waveguides suitable for use in embodiments according to this disclosure can include a single core (such as core 216) embedded in a dielectric layer (such as dielectric layer 218). Similarly, and as discussed elsewhere herein, compensating waveguides can include first and second cores (such as first and second cores 215 and 217). To avoid the confounding effects, such as energy loss, and unwanted reflections associated with an abrupt transition from a single core waveguide to a double core waveguide, transition region 500 includes a region in which second core 217 gradually transitions from an almost-zero width at a leading point 501 to its full width at a terminal point. This gradual progression in the width of second core 217 is further illustrated in the cross-sectional views shown in FIG. 5B, which are taken at the cut lines marked “A,” “B” and “C” in FIG. 5A.

Although FIGS. 5A-5B illustrate one example of transition region 500, embodiments according to the present disclosure are not so limited. For example, while the core 216 of regular waveguide 214 and first core 215 of compensating waveguide 211 have the same cross-sectional profile and second core 217 widens linearly between points 501 and 503 in the illustrative example of FIG. 5A, other geometries are possible and within the contemplated scope of this disclosure. For example, second core 217 can be designed to transition between cross-sectional profiles across transition region 500 according to other shapes.

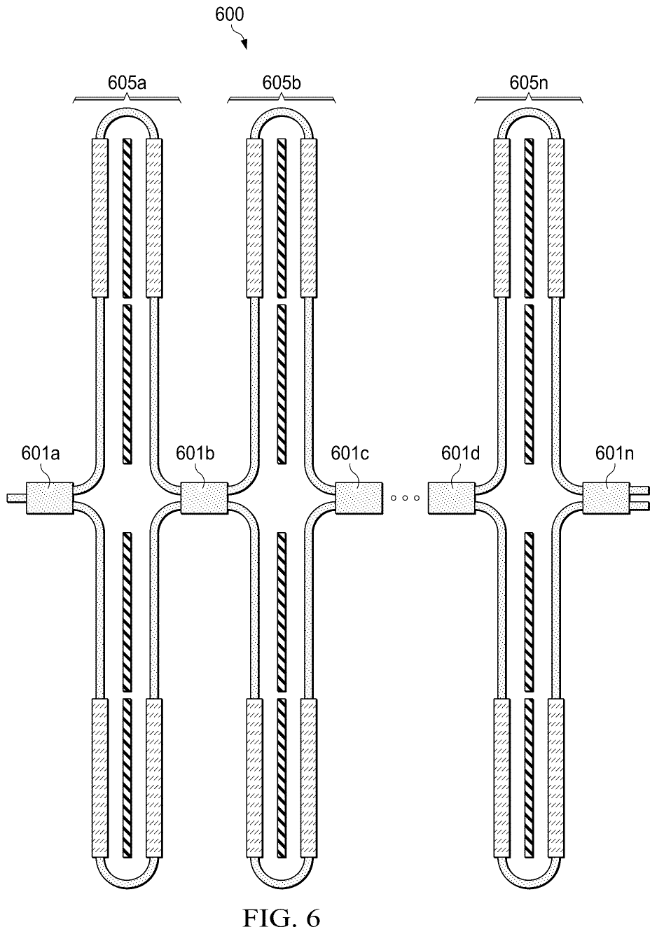

FIG. 6 illustrate an example of a cascaded MZI 600 including a plurality of cascaded delay arm pairs (shown as 605a, 605b and 605n) connected through optical couplers (shown as 601a-601n) according to this disclosure. While only three delay arm pairs are shown in FIG. 6, embodiments according to this disclosure are not so limited, and MZI 600 can have fewer delay arm pairs (such as two) or more delay arm pairs than are shown in the figures. Each delay arm pair of delay arm pairs 605a-605n can embody the architectures shown with reference to FIGS. 3A-4C of this disclosure, where each delay arm of each delay arm pair includes an optical PS with a regular waveguide (such as regular waveguide 214) and a compensated optical PS with a compensated waveguide (such as compensating waveguide 211). The optical properties of the constituent waveguides of the delay arms can be modulated by one or both of thermo-optic effects or electro-optic effects, such as with heaters (such as heater 253a) to change the temperature of the waveguide or electrode pairs (such as second electrode pair 405) exposing the waveguide to an electric field.

Each delay arm pair, together with the two optical couplers connected to the arm pair, can be seen as a child MZI. As such, MZI 600 may be called as “cascaded” MZI, which may be used as an optical filter to improve the passband flatness or as an optical signal processor. In a cascaded MZI structure such as MZI 600, maintaining a predictable FSR relationship across all child MZIs is a significant factor in achieving a desired optical performance for MZI 600.

Absent a compensating PS in each delay arm, the child MZIs of MZI 600 can be susceptible to the FSR drift issues described with reference to FIGS. 1A-1F, and the desired FSR relationship among all child MZIs cannot be maintained during optical phase tuning enabled by regular optical PS only. MZI 600 addresses these issues by cascading one or more types of compensated MZIs (such as MZI 200, 300, or 400) as the child MZIs. In addition, MZI 600 also inherits the enhanced FSR tunability from MZI 200, MZI 300 or MZI 400, which can be beneficial to improving device yield and FSR configurability.

Although FIG. 6 illustrates one example of an MZI 600, embodiments according to the present disclosure are not so limited, and can, for example, include embodiments in which the optical properties of the regular waveguides and compensating waveguides are, modulated using the electro-optic effect, rather than the thermo-optic effect. Additionally, or alternatively, in other embodiments, only one delay arm of a delay arm pair comprises a compensating waveguide.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A Mach-Zehnder interferometer comprising:
a first delay arm;
a second delay arm;
a first phase shifter;
a second phase shifter;
a third phase shifter;
an input optical coupler connected to the first delay arm and the second delay arm; and
an output optical coupler connected to the first delay arm and the second delay arm;
wherein the first phase shifter is provided on the first delay arm;
wherein the second phase shifter is provided on the second delay arm; and
wherein the third phase shifter is provided on the second delay arm.

2. The Mach-Zehnder interferometer of claim 1, wherein:
the first phase shifter is a thermo-optic phase shifter comprising an optical waveguide of a first type of optical waveguide;
the second phase shifter is a thermo-optic phase shifter comprising an optical waveguide of a second type of optical waveguide;
the third phase shifter is a thermo-optic phase shifter comprising an optical waveguide of the first type of optical waveguide;
a group-index sensitivity to temperature of the first type of optical waveguide is larger than a group-index sensitivity to temperature of the second type of optical waveguide;
an effective-index sensitivity to temperature of the first type of optical waveguide is smaller than an effective-index sensitivity to temperature of the second type of optical waveguide;
the first type of optical waveguide comprises a substrate, a first core, at least one second core interacting with the first core, and one or more dielectric layers covering the first core and the at least one second core; and
the second type of optical waveguide comprises a second substrate, a third core, and one or more second dielectric layers covering the third core.

3. The Mach-Zehnder interferometer of claim 2, wherein:
the first phase shifter comprises at least one heater proximate to the optical waveguide of the first type of optical waveguide to tune a first phase shift and a first group delay of the first delay arm via a thermo-optic effect; and
the second phase shifter comprises at least one heater proximate to the optical waveguide of the second type of optical waveguide to tune a second phase shift and a second group delay of the second delay arm via the thermo-optic effect; and
the third phase shifter comprises at least one heater proximate to the optical waveguide of the first type of optical waveguide.

4. The Mach-Zehnder interferometer of claim 2, wherein:
the at least one second core has a lower refractive index than the first core;
the at least one second core has a lower thermo-optic coefficient than the first core; and
the one or more dielectric layers have a lower refractive index than the first and second cores and a lower thermo-optic coefficient than the first core.

5. The Mach-Zehnder interferometer of claim 2, wherein the one or more dielectric layers include at least one of: a silicon dioxide layer, a silicon oxynitride (SiON) layer, a silicon nitride layer, a fluorosilicate glass layer, a borosilicate glass layer, a phosphosilicate glass layer, borophosphosilicate glass layer, a carbon doped oxide layer, or an organic polymer layer.

6. The Mach-Zehnder interferometer of claim 2, wherein the first phase shifter, the second phase shifter, and the third phase shifter are configured concurrently to provide a desired differential phase shift between the first delay arm and the second delay arm and a desired free spectral range.

7. The Mach-Zehnder interferometer of claim 1, wherein:
the first phase shifter is an electro-optic phase shifter comprising an optical waveguide of a first type of optical waveguide;
the second phase shifter is an electro-optic phase shifter comprising an optical waveguide of a second type of optical waveguide;
the third phase shifter is an electro-optic phase shifter comprising an optical waveguide of the first type of optical waveguide;
a group-index sensitivity to electrical field intensity across the first type of optical waveguide is larger than a group-index sensitivity to electrical field intensity of the second type of optical waveguide;
an effective-index sensitivity to electrical field intensity across the first type of optical waveguide is smaller than an effective-index sensitivity to electrical field intensity of the second type of optical waveguide;
the first type of optical waveguide comprises a substrate, a first core, at least one second core interacting with the first core, and one or more dielectric layers covering the first core and the at least one second core; and
the second type of optical waveguide comprises a second substrate, a third core, and one or more second dielectric layers covering the third core.

8. The Mach-Zehnder interferometer of claim 7, wherein:
the first phase shifter comprises at least two electrodes proximate to the optical waveguide of the first type of optical waveguide in the first delay arm and is configured to tune phase shift and group delay of the first delay arm via an electro-optic effect;
the second phase shifter comprises at least two electrodes proximate to the optical waveguide of the second type of optical waveguide in the second delay arm and is configured to tune phase shift and group delay of the second delay arm via the electro-optic effect; and
the third phase shifter comprises at least two electrodes proximate to the optical waveguide of the first type of optical waveguide in the second delay arm and is configured to tune phase shift and group delay of the second delay arm via the electro-optic effect.

9. The Mach-Zehnder interferometer of claim 7, wherein:
the at least one second core has a lower refractive index than the first core;
the at least one second core has a lower electro-optic coefficient than the first core; and
the one or more dielectric layers have a lower refractive index than the first and second cores and a lower electro-optic coefficient than the first core.

10. The Mach-Zehnder interferometer of claim 7, wherein the one or more dielectric layers include at least one of: a silicon dioxide layer, a silicon oxynitride (SiON) layer, a silicon nitride layer, a fluorosilicate glass layer, a borosilicate glass layer, a phosphosilicate glass layer, borophosphosilicate glass layer, a carbon doped oxide layer, or an organic polymer layer.

11. The Mach-Zehnder interferometer of claim 7, wherein the first phase shifter, the second phase shifter, and the third phase shifter are configured concurrently to provide a desired differential phase shift between the first delay arm and the second delay arm and a desired free spectral range.

12. The Mach-Zehnder interferometer of claim 1, wherein:
the input optical coupler is one of: a multimode interference coupler, a directional coupler, or an adiabatic coupler; and
the output optical coupler is one of: a multimode interference coupler, a directional coupler, or an adiabatic coupler.

13. The Mach-Zehnder interferometer of claim 1, further comprising a fourth phase shifter, wherein the fourth phase shifter is provided on the first delay arm and is configured to provide phase tuning and group delay tuning of the first delay arm.

14. The Mach-Zehnder interferometer of claim 2, further comprising one or more optical mode converters configured to convert an optical mode of the first type of optical waveguide to an optical mode of the second type of optical waveguide.

15. A cascaded Mach-Zehnder interferometer comprising:
a plurality of delay arm pairs, wherein each delay arm pair of the plurality of delay arm pairs comprises at least one of an input optical coupler and an output optical coupler, the input optical coupler of a first delay arm pair configured to receive an optical input signal, the output optical coupler of a last delay arm pair configured to output optical signals;
wherein the first delay arm pair and the last delay arm pair are connected directly via an intermediate optical coupler or indirectly by one or more delay arm pairs of the plurality of delay arm pairs.

16. The cascaded Mach-Zehnder interferometer of claim 15, wherein each delay arm pair comprises:
a first phase shifter;
a second phase shifter; and
a third phase shifter;
wherein the first phase shifter is provided on a first delay arm of the delay arm pair;
wherein the second phase shifter is provided on a second delay arm of the delay arm pair; and
wherein the third phase shifter is provided on the second delay arm of the delay arm pair.

17. The cascaded Mach-Zehnder interferometer of claim 16, wherein, in each delay arm pair:
the first phase shifter comprises an optical waveguide of a first type of optical waveguide;
the second phase shifter comprises an optical waveguide of a second type of optical waveguide; and
the third phase shifter comprises an optical waveguide of the first type of optical waveguide;
a group-index sensitivity to temperature or electrical field intensity of the first type of optical waveguide is larger than a group-index sensitivity to temperature or electrical field intensity of the second type of optical waveguide;
an effective-index sensitivity to temperature of the first type of optical waveguide is smaller than an effective-index sensitivity to temperature or electrical field intensity of the second type of optical waveguide;
the first type of optical waveguide comprises a substrate, a first core, at least one second core interacting with the first core, and one or more dielectric layers covering the first core and the at least one second core; and
the second type of optical waveguide comprises a second substrate, a third core, and one or more second dielectric layers covering the third core.

18. The cascaded Mach-Zehnder interferometer of claim 17, wherein, in each delay arm pair:
the at least one second core has a lower refractive index than the first core;
the at least one second core has a lower thermo-optic coefficient or electro-optic coefficient than the first core; and
the one or more dielectric layers have a lower refractive index than the first and second cores and a lower thermo-optic coefficient or electro-optic coefficient than the first core.

19. The cascaded Mach-Zehnder interferometer of claim 17, further comprising heaters proximate to the optical waveguides of the first and second types and configured to induce temperature changes in the optical waveguides.

20. The cascaded Mach-Zehnder interferometer of claim 17, further comprising electrodes proximate to the optical waveguides of the first and second types and configured to induce electrical field changes across the optical waveguides.
